(19) United States
(12) Patent Application Publication
(10) Pub. No.: US 2025/0113363 A1
(43) Pub. Date: Apr. 3, 2025

(54) SKIPPING TRANSMISSION OF UPLINK CONTROL INFORMATION

(71) Applicant: Nokia Technologies Oy, Espoo (FI)

(72) Inventors: Umar SAEED, Espoo (FI); Jorma Johannes KAIKKONEN, Oulu (FI); Margarita GAPEYENKO, Espoo (FI); Stefano PARIS, Vanves (FR); Zexian LI, Espoo (FI)

(21) Appl. No.: 18/897,765

(22) Filed: Sep. 26, 2024

(30) Foreign Application Priority Data
Sep. 28, 2023 (FI) 20236084

(51) Int. Cl. H04W 72/21

(52) U.S. Cl. CPC H04W 72/21

(57) ABSTRACT

Disclosed is a method comprising receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determining, based on the one or more rules, whether to skip at least one scheduled transmission of the uplink control information.

### FIELD

The following example embodiments relate to wireless communication.

### BACKGROUND

As energy and network resources are limited, it is desirable to provide solutions for power saving and for optimizing the usage of network resources.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: receive, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determine, based on the one or more rules, whether to skip at least one scheduled transmission of the uplink control information.

According to another aspect, there is provided an apparatus comprising: means for receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and means for determining, based on the one or more rules, whether to skip at least one scheduled transmission of the uplink control information.

According to another aspect, there is provided a method comprising: receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determining, based on the one or more rules, whether to skip at least one scheduled transmission of the uplink control information.

According to another aspect, there is provided a computer program comprising instructions which, when executed by an apparatus, cause the apparatus to perform at least the following: receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determining, based on the one or more rules, whether to skip at least one scheduled transmission of the uplink control information.

According to another aspect, there is provided a computer readable medium comprising program instructions which, when executed by an apparatus, cause the apparatus to perform at least the following: receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determining, based on the one or more rules, whether to skip at least one scheduled transmission of the uplink control information.

According to another aspect, there is provided a non-transitory computer readable medium comprising program instructions which, when executed by an apparatus, cause the apparatus to perform at least the following: receiving, from a radio access network node, a configuration indicating one or more rules for skipping a transmission of uplink control information, wherein the one or more rules comprise at least a condition that an indication indicating one or more unused configured grant physical uplink shared channel transmission occasions has been transmitted; and determining, based on the one or more rules, whether to skip at least one scheduled transmission of the uplink control information.

According to another aspect, there is provided an apparatus comprising at least one processor, and at least one memory storing instructions that, when executed by the at least one processor, cause the apparatus at least to: generate a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and transmit the configuration to the user equipment.

According to another aspect, there is provided an apparatus comprising: means for generating a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and means for transmitting the configuration to the user equipment.

According to another aspect, there is provided a method comprising: generating a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and transmitting the configuration to the user equipment.

According to another aspect, there is provided a computer program comprising instructions which, when executed by an apparatus, cause the apparatus to perform at least the following: generating a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and transmitting the configuration to the user equipment.

According to another aspect, there is provided a computer readable medium comprising program instructions which, when executed by an apparatus, cause the apparatus to perform at least the following: generating a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and transmitting the configuration to the user equipment.

According to another aspect, there is provided a non-transitory computer readable medium comprising program instructions which, when executed by an apparatus, cause the apparatus to perform at least the following: generating a configuration for a user equipment, the configuration indicating one or more rules for skipping a transmission of uplink control information, wherein the one or more rules comprise at least a condition that an indication indicating one or more unused configured grant physical uplink shared channel transmission occasions has been transmitted from the user equipment; and transmitting the configuration to the user equipment.

### LIST OF DRAWINGS

In the following, various example embodiments will be described in greater detail with reference to the accompanying drawings, in which:

FIG. 1 illustrates an example of a wireless communication network;

FIG. 2 illustrates an example of uplink control information carried by a non-overlapping physical uplink control channel;

FIG. 3 illustrates an example of uplink control information multiplexed on a physical uplink shared channel;

FIG. 4 illustrates a signal flow diagram;

FIG. 5 illustrates a signal flow diagram;

FIG. 6 illustrates a signal flow diagram;

FIG. 7 illustrates a signal flow diagram;

FIG. 8 illustrates a signal flow diagram;

FIG. 9 illustrates a flow chart;

FIG. 10 illustrates a flow chart;

FIG. 11 illustrates an example of a single-stream traffic model for uplink video traffic;

FIG. 12 illustrates an example of a distribution of frame size;

FIG. 13 illustrates an example of an apparatus; and

FIG. 14 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Some example embodiments described herein may be implemented in a wireless communication network comprising a radio access network based on one or more of the following radio access technologies (RATs): Global System for Mobile Communications (GSM) or any other second generation radio access technology, Universal Mobile Telecommunication System (UMTS, 3G) based on basic wideband-code division multiple access (W-CDMA), high-speed packet access (HSPA), Long Term Evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the Evolved Universal Terrestrial Radio Access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications. IEEE is an abbreviation for the Institute of Electrical and Electronics Engineers.

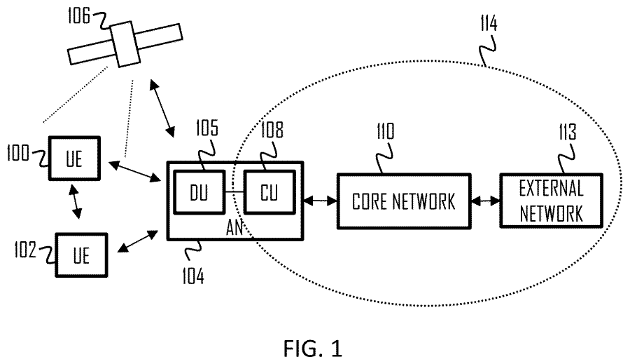

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with an access node (AN) 104 of an access network. The AN 104 may be an evolved NodeB (abbreviated as eNB or eNodeB), or a next generation evolved NodeB (abbreviated as ng-eNB), or a next generation NodeB (abbreviated as gNB or gNodeB), providing the radio cell. The wireless connection (e.g., radio link) from a UE to the access node 104 may be called uplink (UL) or reverse link, and the wireless connection (e.g., radio link) from the access node to the UE may be called downlink (DL) or forward link. UE 100 may also communicate directly with UE 102, and vice versa, via a wireless connection generally referred to as a sidelink (SL). It should be appreciated that the access node 104 or its functionalities may be implemented by using any node, host, server or access point etc. entity suitable for providing such functionalities.

The access network may comprise more than one access node, in which case the access nodes may also be configured to communicate with one another over links, wired or wireless. These links between access nodes may be used for sending and receiving control plane signaling and also for routing data from one access node to another access node.

The access node may comprise a computing device configured to control the radio resources of the access node. The access node may also be referred to as a base station, a base transceiver station (BTS), an access point, a cell site, a radio access node or any other type of node capable of being in a wireless connection with a UE (e.g., UEs 100, 102). The access node may include or be coupled to transceivers. From the transceivers of the access node, a connection may be provided to an antenna unit that establishes bi-directional radio links to UEs 100, 102. The antenna unit may comprise an antenna or antenna element, or a plurality of antennas or antenna elements.

The access node 104 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise one or more network functions, such as at least one of: a user plane function (UPF), an access and mobility management function (AMF), a location management function (LMF), and/or a session management function (SMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

It should be appreciated that a UE may also be a nearly exclusive uplink-only device, of which an example may be a camera or video camera loading images or video clips to a network. A UE may also be a device having capability to operate in an Internet of Things (IoT) network, which is a scenario in which objects may be provided with the ability to transfer data over a network without requiring human-to-human or human-to-computer interaction. The UE may also utilize cloud. In some applications, the computation may be carried out in the cloud or in another UE.

The wireless communication network may also be able to support the usage of cloud services, for example at least part of core network operations may be carried out as a cloud service (this is depicted in FIG. 1 by “cloud” 114). The wireless communication network may also comprise a central control entity, or the like, providing facilities for wireless communication networks of different operators to cooperate for example in spectrum sharing.

5G enables using multiple input-multiple output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, access nodes and/or UEs may have multiple radio interfaces, namely below 6 GHz, cmWave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

In some example embodiments, an access node (e.g., access node 104) may comprise: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node. The DU 105 may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU 105 and CU 108 may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU 105) and non-real-time functions being carried out in a centralized manner (e.g., in a CU 108).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by an access node 104 located on-ground or in a satellite.

It is obvious for a person skilled in the art that the access node 104 depicted in FIG. 1 is just an example of a part of an access network (e.g., a radio access network) and in practice, the access network may comprise a plurality of access nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of access networks, the concept of “plug-and-play” access nodes may be introduced. An access network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

Capacity improvements and UE power saving are being considered in NR Release 18, for example for extended reality (XR) use cases. The focus on power saving has mainly been on enabling the configuration and adjustment of connected mode discontinuous reception (CDRX) parameters according to the XR traffic pattern. For the capacity improvements, there is an agreement for solutions to meet the high data rate and low latency requirements of XR traffic.

In this regard, multiple configured grant (CG) physical uplink shared channel (PUSCH) transmission occasions in a period of a single CG PUSCH configuration has been agreed as an objective for NR Release 18. Furthermore, dynamic indication of unused CG PUSCH transmission occasion(s) by the UE based on uplink control information (UCI) has also been agreed as an objective for NR Release 18.

Since XR video packets have varying frame sizes, the indication of unused CG PUSCH occasions may be beneficial to avoid wasting unused (i.e., not needed) PUSCH resources and to reduce UE power consumption.

The following agreements on the indication of unused CG PUSCH transmission occasions in a multiple CG PUSCH configuration have been made. Firstly, for a CG PUSCH configuration, the unused transmission occasion uplink control information (UTO-UCI) may be included in every CG PUSCH that is transmitted. The UTO-UCI refers to the UCI that provides information about unused CG PUSCH transmission occasions. Secondly, when a CG PUSCH occasion is indicated as “unused”, the UE is not allowed to transmit CG PUSCH on that CG PUSCH occasion. For any other CG PUSCH occasion that is not indicated as “unused”, the UE may be allowed to transmit or not transmit CG PUSCH on that CG PUSCH transmission occasion.

Based on the above agreements, the UE may indicate, via the UTO-UCI, the CG PUSCH transmission occasions that the UE does not need (e.g., does not have any UL user data to transmit in them). UTO-UCI can only be transmitted on PUSCH.

In addition to the capacity enhancement opportunity (by allowing the network to reschedule the unused CG PUSCH transmission occasion of the UE to other UEs), skipping (omitting) PUSCH transmissions may provide power saving opportunities for the UE.

A PUSCH transmission may be skipped, when there is no data to be transmitted, and UL skipping is enabled. However, according to the current specifications, uplink control information (UCI) transmitted by a physical uplink control channel (PUCCH), or UCI multiplexed on PUSCH, will always be transmitted. Thus, a PUCCH or PUSCH scheduled to carry such UCI will be transmitted (according to the current specifications).

Whereas capacity gains may arise from re-using transmission resources, power savings may require avoiding unnecessary transmissions. However, currently, there are no solutions for indicating unused transmission of UCI, such as channel state information, which could, in principle, be delayed to a later transmission opportunity with minimal impact.

UCI may be carried, depending on the configuration, either by the dedicated control channel (i.e., PUCCH) or multiplexed with the uplink data channel (i.e., PUSCH). The UCI may comprise, for example, at least one of the following elements: hybrid automatic repeat request (HARQ) feedback, a scheduling request (SR), and/or channel state information (CSI). The HARQ feedback may refer to a HARQ acknowledgement (ACK) or a HARQ negative acknowledgement (NACK). It should be noted that not all of these different elements (HARQ feedback, SR and CSI) are always carried by a single UCI. Depending on the situation, a single UCI may comprise one or more of these elements.

A CSI report from the UE may be needed for the RAN node (e.g., gNB) to be able to select the optimal modulation and coding scheme (MCS) for DL transmissions. However, if the UE is in a no mobility or low mobility state, the channel between the UE and the RAN node is not expected to change significantly in the near future. Thus, a UCI transmission, which carries the CSI report, may be skipped if there is no other urgent information to be carried as well, and if the channel is not expected to change significantly. CSI may be configured to be transmitted periodically or semi-periodically.

However, according to the current specifications, there may be situations where the transmission of UCI carried by PUCCH or a PUSCH may still need to be done, even when there is no UE data and no HARQ feedback to be transmitted. Such a scenario may arise, for example, when there is no DL data received by the UE prior to the scheduled transmission of UCI, but UCI may still need to be transmitted due to periodic or semi-periodic CSI.

This may result in considerable overhead in terms of resource usage and UE power consumption (e.g., in cases where the CSI could be delayed to the next available transmission opportunity). For example, according to the current specifications, when a certain PUSCH occasion in a multiple CG PUSCH configuration is indicated as unused in a UTO-UCI, it may still need to be transmitted for carrying the UCI.

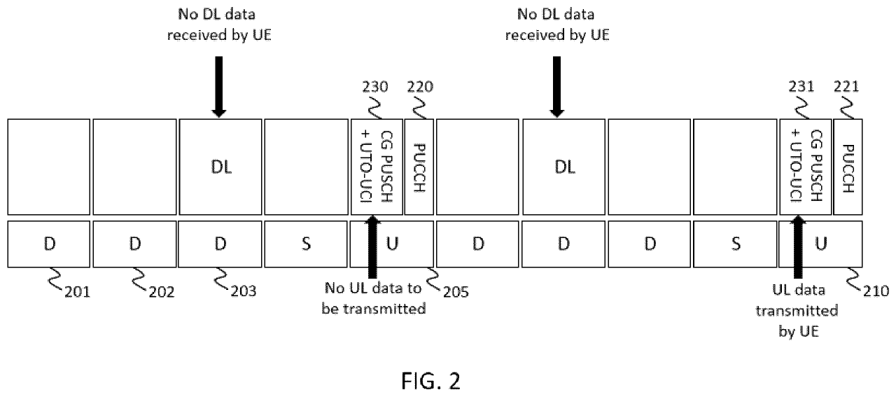

FIG. 2 illustrates an example of UCI carried by a non-overlapping PUCCH 220, 221. When a dedicated non-overlapping PUCCH is scheduled to carry a UCI, configured for periodic or semi-periodic CSI and HARQ feedback, it may always be transmitted (according to the current specifications). In this case, even when there is no HARQ feedback to be sent to the RAN node, the UCI is still transmitted for the periodic CSI reports.

In FIG. 2, during the first DDDSU radio frame, no DL data is received in the DL slots 201, 202, 203. Herein “D” refers to a downlink slot, “S” refers to a special slot, and “U” refers to an uplink slot. A non-overlapping PUCCH 220, configured to carry a UCI with periodic or semi-periodic CSI and HARQ feedback, is scheduled in the same UL slot 205 as PUSCH and UTO-UCI 230. In this case, transmission of the PUSCH 230 is skipped, since there is no UL data to be transmitted. However, the PUCCH 220 will still be transmitted because of the CSI. Similarly, in the following DDDSU radio frame, the PUCCH 221 is again transmitted in the UL slot 210, although there is no DL data received in a prior DL slot. The PUSCH 231 is also transmitted in the UL slot 210 because of UE UL data.

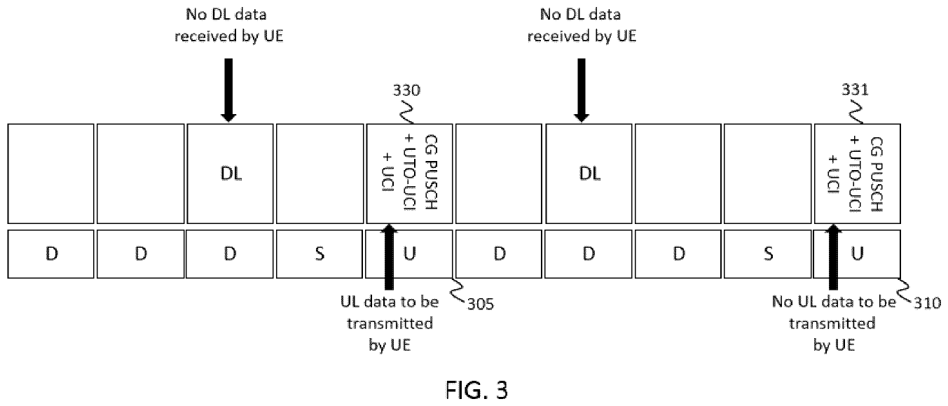

FIG. 3 illustrates an example of UCI multiplexed on a PUSCH 330, 331. When a UCI (to carry CSI and HARQ feedback) is configured to be multiplexed on a PUSCH 330, 331, skipping the PUSCH may not be possible, even when there is no UE UL data or HARQ feedback to be transmitted, because of the periodic or semi-periodic CSI. This is because of the current specifications, according to which the PUSCH transmission cannot be skipped, if there is a UCI to be multiplexed on the PUSCH resources.

In FIG. 3, there are two DDDSU radio frames, in which PUSCH 330, 331 is transmitted. In the UL slot 305, there is UL data to be transmitted, and therefore the PUSCH 330 is transmitted. However, in the UL slot 310, the PUSCH 331 is also transmitted due to the periodic CSI, even when there is no UL data to be transmitted and no HARQ feedback, either.

Furthermore, there may be scenarios, where a UE is configured to skip monitoring of the physical downlink control channel (PDCCH). In such cases, the UE does not expect any reception of DL data, meaning that there is no HARQ feedback to be reported as well. In this case, periodic reporting of CSI may also be not necessary, as long as skipping PDCCH monitoring is configured.

Moreover, a UE may be configured to skip the scheduled UL transmissions under certain conditions in a given (active) search space set group (SSSG). However, when the UE is asked to monitor another SSSG (i.e., configured with SSSG switching), the UE may need to transmit frequent CSI reports, even when there is no other reason for UL transmissions. Such a scenario could also be considered for skipping the UCI.

The transmission of CSI, when the UE has no data to be transmitted in UL and/or no HARQ feedback to be reported in UL, is inefficient in terms of UE power consumption, resource usage and interference mitigation perspectives. The UE could benefit from additional power saving by indicating unused PUCCH, carrying, for example, UCI with periodic or semi-periodic CSI, or PUSCH with multiplexed UCI. Therefore, in terms of UE power saving and efficient resource usage, it may be beneficial to provide conditions or rules under which transmission of a UCI over PUCCH or multiplexed on PUSCH could be skipped, after the UE has signaled, via the UTO-UCI, that certain CG PUSCH transmission occasions will be “not used”.

Some example embodiments may address the above issues by enabling the UE to skip the transmission of a UCI carried by PUCCH or multiplexed on PUSCH, based on one or more rules configured by the RAN node (e.g., based on whether the UCI is time sensitive or not).

For example, in combination of the UTO-UCI indication of “not used” CG PUSCH transmission occasions, the UE may be configured to allow skipping (or omitting) the UCI transmission on corresponding slots or transmission occasions of PUCCH or PUSCH based on one or more of the following conditions: the PUSCH transmission does not carry any UL user data, the UCI transmission does not comprise HARQ feedback for a DL PDSCH transmission, the UCI carries only a CSI report, the UE is not under a high mobility state, a measured reference signal received power (RSRP) level from the RAN node is higher than a first threshold (e.g., s-MeasureConfig), and/or the time since a previous CSI report was transmitted from the UE is below a second threshold.

As an example, in FIG. 2, the transmission of the PUCCH 220, 221 may be skipped, if the PUCCH is carrying CSI but no HARQ feedback.

As another example, in FIG. 3, the transmission of the PUSCH 331 may be skipped, if the PUSCH is carrying CSI but no UL data and no HARQ feedback.

Alternatively, or additionally, the skipping of the UCI transmission (e.g., CSI) may be conditioned on the DL power saving techniques applied at the UE. For example, if the UE has been indicated to apply PDCCH skipping, and the UE indicates, via UTO-UCI, that certain CG PUSCH transmission occasions are “not used”, the UE may assume that UCI (e.g., CSI) transmission on PUCCH can also be skipped, or that the UE is allowed to indicate a PUSCH with such UCI multiplexed as unused.

As another example, if the UE has been indicated, for example by downlink control information (DCI), to monitor based on a certain SSSG, and the UE indicates, via UTO-UCI, that certain CG-PUSCH transmission occasions are “not used”, the UE may assume that UCI (e.g., CSI) transmission on PUCCH can also be skipped, or that the UE is allowed to indicate a PUSCH with such UCI multiplexed as unused.

The UL transmission of the UCI (e.g., CSI) may be skipped in the slots, where the UTO-UCI indicates CG-PUSCH transmission occasions as “not used”.

Alternatively, the UL transmission of the UCI (e.g., CSI) may be skipped in the slots that fall between CG PUSCH transmission occasions that were indicated by UTO-UCI as “not unused” (i.e., used), including also slots where no CG PUSCH transmission occasion resides. For example, the UL slots where the UCI transmission is skipped may refer to the slots between the last CG PUSCH transmission occasion that were indicated by UTO-UCI as used within a CG period and the first (used) CG PUSCH transmission occasion of the next CG period, provided that no threshold on the time between two consecutive CSI reports is configured by the RAN node.

Some example embodiments are described below using principles and terminology of 5G radio access technology without limiting the example embodiments to 5G radio access technology, however.

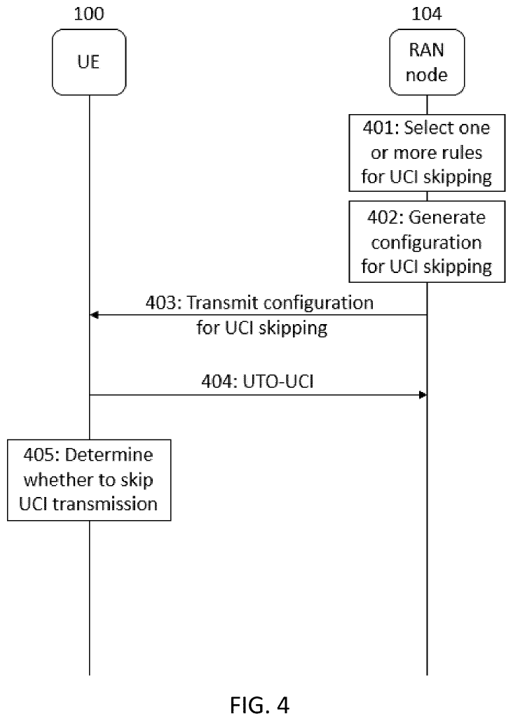

FIG. 4 illustrates a signal flow diagram according to an example embodiment. The UE 100 of FIG. 4 may be in connected mode (RRC_CONNECTED) with the RAN node 104. For example, the RAN node 104 may comprise a gNB.

Referring to FIG. 4, at 401, the RAN node 104 selects or determines, for the UE 100, one or more rules, possibly from a set of pre-defined or pre-configured rules for skipping a transmission of UCI, wherein the selection/determination is based on at least one of: whether the UE 100 is expected to transmit uplink user data, whether the UE 100 is expected to transmit HARQ feedback for a downlink transmission, whether the UE 100 is expected to transmit a CSI report, whether the UE 100 is under a high mobility state, a measured RSRP level reported from the UE 100, a time duration since the UE 100 transmitted a previous CSI report, or downlink power saving settings of the UE 100. In an embodiment, these options may be comprised in the set of pre-defined or pre-configured rules, and the RAN node 104 may select one or more from this set.

In an embodiment, the RAN node 104 may configure same one or more rules to all UEs in a cell of the RAN node. In another embodiment, the one or more rules are dedicated to one or more UEs (e.g., one or a subset of all the UEs in the cell of the RAN node).

Herein the high mobility state may mean, for example, that the UE 100 is moving at or above a predetermined velocity threshold, such as 5 kilometers per hour. The mobility states of the UE 100 may be determined according to how quickly the channel condition between the UE 100 and the RAN node 104 changes.

At 402, the RAN node 104 generates, for the UE 100, a configuration indicating the one or more rules.

At 403, the RAN node 104 transmits the configuration to the UE 100. The UE 100 receives the configuration.

At 404, the UE 100 transmits, to the RAN node 104, an indication indicating one or more unused CG PUSCH transmission occasions in the future. Alternatively, the indication may indicate that all CG PUSCH transmission occasions in the reporting window are used (i.e., “not unused”). The RAN node 104 receives the indication. This indication may refer to the UTO-UCI mentioned above.

At 405, the UE 100 determines, based on the one or more rules, whether to skip at least one scheduled transmission of UCI. The at least one scheduled transmission of UCI may be scheduled (by the RAN node 104) in one or more slots comprising or in between the one or more unused CG PUSCH transmission occasions indicated at 404.

The one or more rules comprise at least a condition that an indication indicating one or more unused CG PUSCH transmission occasions has been transmitted from the UE 100. In this case, this condition is fulfilled due to the indication transmitted at 404.

The one or more rules may also comprise one or more additional conditions. For example, the one or more rules may indicate to skip the at least one scheduled transmission of the UCI based on at least one of the following conditions: if the at least one scheduled transmission does not carry any uplink user data, if the UCI does not carry HARQ feedback for a downlink transmission, if the UCI carries a CSI report, if the UE 100 is not under a high mobility state, if a measured RSRP level from the RAN node 104 at the UE 100 is higher than a first threshold, if a time duration since transmitting a previous CSI report is less than a second threshold, if the UE 100 is configured to skip PDCCH monitoring, and/or if SSSG switching is enabled at the UE 100.

Herein the terms “first threshold” and “second threshold” are used to distinguish the thresholds. In other words, the first threshold may be different than the second threshold. The first threshold and/or the second threshold may be set by the RAN node 104 in the configuration.

Based on the determination at 405, the UE 100 may either skip the at least one scheduled transmission of the UCI, or transmit the at least one scheduled transmission of the UCI. In other words, the UE 100 may skip the at least one scheduled transmission of the UCI, based on determining to skip the at least one scheduled transmission of the UCI. Alternatively, the UE 100 may transmit the at least one scheduled transmission of the UCI, based on determining to not skip the at least one scheduled transmission of the UCI.

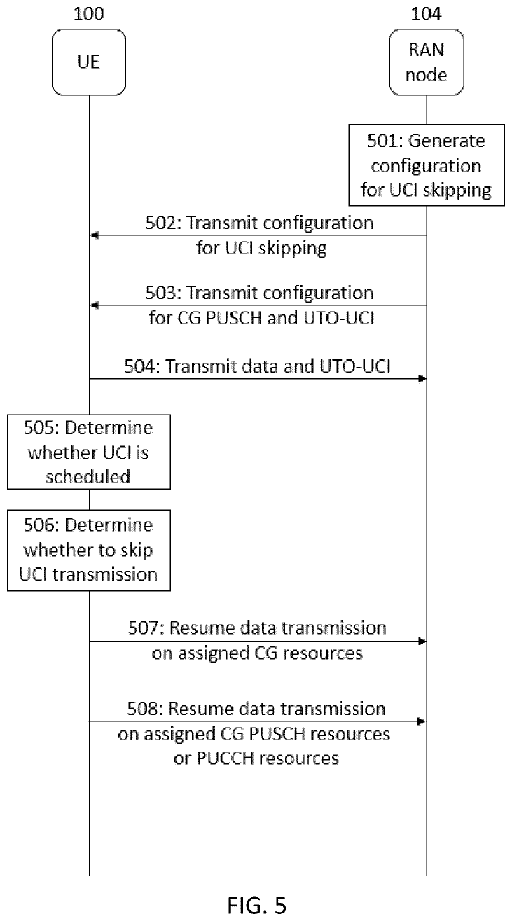

FIG. 5 illustrates a signal flow diagram according to an example embodiment for skipping UCI carried by a non-overlapping PUCCH (e.g., PUCCH 220 or 221 of FIG. 2). The UE 100 of FIG. 5 may be in connected mode (RRC_CONNECTED) with the RAN node 104. For example, the RAN node 104 may comprise a gNB.

Referring to FIG. 5, at 501, the RAN node 104 generates, for the UE 100, a configuration indicating one or more rules for skipping a transmission of UCI. For example, the RAN node 104 may select/determine the one or more rules as described above at 401 of FIG. 4.

At 502, the RAN node 104 transmits the configuration to the UE 100. The UE 100 receives the configuration.

At 503, the RAN node 104 transmits, to the UE 100, a configuration for CG PUSCH and UTO-UCI. The UE 100 receives the configuration. The configuration of the UTO-UCI may also be preconfigured to the UE and need not be transmitted to the UE. In some embodiments of FIGS. 5 to 8, the UTO-UCI configuration is not sent to the UE. Also, the CG PUSCH configuration may be skipped at this point in case the configured grants have already been semi-persistently scheduled.

One or more CG PUSCH transmissions may be configured by a configuredGrantConfig. If the UE is provided nrof_UTO_UCI with a value equal to OUTO-UCI in the configuredGrantConfig of the CG PUSCH configuration, the UE may multiplex UTO-UCI represented by a bitmap of OUTO-UCI bits in each CG PUSCH transmission for the CG PUSCH configuration. At 504, the UE 100 transmits, to the RAN node 104, UL data on the CG resources assigned by the configuration at 503, and an indication (i.e., UTO-UCI) indicating one or more unused CG PUSCH transmission occasions in the future. The RAN node 104 receives the UL data and the UTO-UCI.

The OUTO-UCI bits of UTO-UCI may have a one-to-one mapping to OUTO-UCI of subsequent CG PUSCH transmission occasions in ascending order of start time. For unpaired spectrum operation, the OUTO-UCI of subsequent CG PUSCH transmission occasions may exclude invalid ones, where the UE does not transmit a PUSCH. A bit value of ‘0’ may indicate that the UE may transmit CG PUSCH, and a bit value of ‘1’ may indicate that the UE will not transmit CG PUSCH, in a corresponding CG PUSCH transmission occasion. When the UE indicates, by UTO-UCI, a value of ‘1’ for a CG-PUSCH transmission occasion, the UE may continue to indicate the value of ‘1’ for the CG PUSCH transmission occasion by UTO-UCI multiplexed in subsequent CG PUSCH transmissions, and the UE does not transmit CG PUSCH in the CG PUSCH transmission occasion.

At 505, when one or more CG PUSCH transmission occasions are indicated as unused (at 504), the UE 100 determines whether at least one transmission of UCI is scheduled to be transmitted in one or more slots comprising or in between the one or more unused CG PUSCH transmission occasions indicated at 504.

At 506, if the UCI is scheduled, the UE 100 determines, based on the one or more rules, whether to skip the at least one scheduled transmission of the UCI.

For example, if the UCI only comprises CSI reporting information (and no other UCI, such as HARQ feedback), and it would be transmitted in the range of slots from the first CG PUSCH transmission occasion indicated by the UTO-UCI as “unused”, and before the next CG-PUSCH transmission occasion indicated as “not unused”, then the UE 100 may determine to skip the at least one scheduled transmission of the UCI.

Alternatively, if the UCI comprises HARQ feedback (instead of or in addition to the CSI), then the UE 100 may determine to not skip the at least one scheduled transmission of the UCI. In other words, in this case, the UE 100 may transmit the at least one scheduled transmission of the UCI on the PUCCH, regardless of the UTO-UCI indication of 504.

It should be noted that the determination of whether to skip the at least one scheduled transmission of the UCI may also be based on, for example, at least one of the following conditions: the UE 100 is not under a high mobility state, the measured RSRP level from the RAN node 104 is higher than a first threshold (e.g., s-MeasureConfig), or the time duration since the previous CSI report was transmitted is less than a second threshold.

At 507, the UE 100 resumes data transmission on the assigned CG resources.

At 508, the UE 100 resumes data and UCI transmission on the assigned CG PUSCH resources or PUCCH resources.

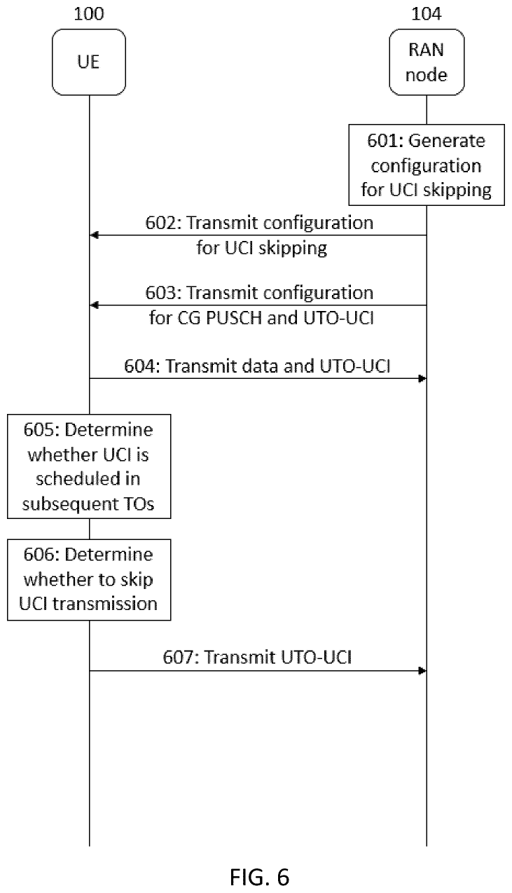

FIG. 6 illustrates a signal flow diagram according to an example embodiment for skipping UCI multiplexed on PUSCH (e.g., PUSCH 330 or 331 of FIG. 3). The UE 100 of FIG. 6 may be in connected mode (RRC_CONNECTED) with the RAN node 104. For example, the RAN node 104 may comprise a gNB.

Referring to FIG. 6, at 601, the RAN node 104 generates, for the UE 100, a configuration indicating one or more rules for skipping a transmission of UCI. For example, the RAN node 104 may select/determine the one or more rules as described above at 401 of FIG. 4.

At 602, the RAN node 104 transmits the configuration to the UE 100. The UE 100 receives the configuration.

At 603, the RAN node 104 transmits, to the UE 100, a configuration for CG PUSCH and UTO-UCI. The UE 100 receives the configuration.

At 604, the UE 100 transmits, to the RAN node 104, UL data on the CG resources assigned by the configuration at 603, and an indication (i.e., UTO-UCI) indicating one or more unused CG PUSCH transmission occasions in the future. The RAN node 104 receives the UL data and the UTO-UCI.

At optional step 605, when evaluating whether one or more subsequent CG PUSCH transmission occasions can be indicated as “unused” or “not unused”, the UE 100 determines whether at least one transmission of UCI is scheduled to be transmitted in the one or more subsequent CG PUSCH transmission occasions. In some other embodiments, the UE 100 decides “unused”/“not unused” CG PUSCH occasions based on data in its buffer, and need not consider whether UCI is scheduled to be transmitted.

At 606, if the UCI is scheduled in the one or more subsequent CG PUSCH transmission occasions, the UE 100 determines, based on the one or more rules, whether to skip the at least one scheduled transmission of the UCI.

For example, if the UCI only comprises CSI reporting information (and no other UCI, such as HARQ feedback), and there is no UL data to be transmitted in the at least one transmission, then the UE 100 may determine to skip the at least one scheduled transmission of the UCI on PUSCH.

Alternatively, if the UCI comprises HARQ feedback (instead of or in addition to the CSI), then the UE 100 may determine to not skip the at least one scheduled transmission of the UCI. In other words, in this case, the UE 100 may transmit the at least one scheduled transmission of the UCI on the PUSCH.

It should be noted that the determination of whether to skip the at least one scheduled transmission of the UCI may also be based on, for example, at least one of the following conditions: the UE 100 is not under a high mobility state, the measured RSRP level from the RAN node 104 is higher than a first threshold (e.g., s-MeasureConfig), or the time duration since the previous CSI report was transmitted is less than a second threshold.

At 607, based on the determination at 606, the UE 100 transmits, to the RAN node 104, an indication (i.e., UTO-UCI) indicating whether the one or more subsequent CG PUSCH transmission occasions are “not unused” or “unused”. For example, if the UE 100 determines to skip the at least one transmission of the UCI, then the UE 100 may indicate the corresponding one or more subsequent CG PUSCH transmission occasions as “unused”. Alternatively, if the UE 100 determines to not skip the at least one transmission of the UCI, then the UE 100 may indicate the corresponding one or more subsequent CG PUSCH transmission occasions as “not unused” (i.e., used).

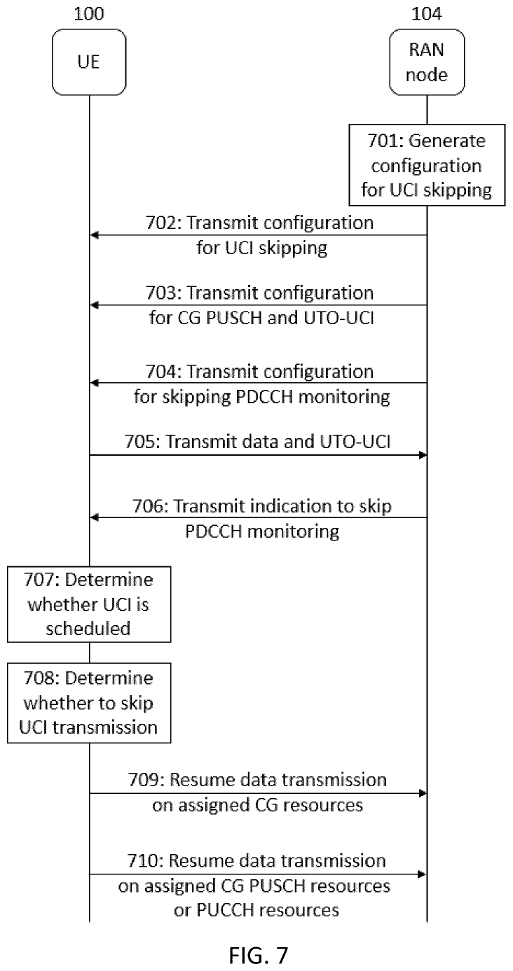

FIG. 7 illustrates a signal flow diagram according to an example embodiment for skipping UCI, when skipping of PDCCH monitoring is configured. The UE 100 of FIG. 7 may be in connected mode (RRC_CONNECTED) with the RAN node 104. For example, the RAN node 104 may comprise a gNB.

Referring to FIG. 7, at 701, the RAN node 104 generates, for the UE 100, a configuration indicating one or more rules for skipping a transmission of UCI. For example, the RAN node 104 may select/determine the one or more rules as described above at 401 of FIG. 4.

At 702, the RAN node 104 transmits the configuration to the UE 100. The UE 100 receives the configuration.

At 703, the RAN node 104 transmits, to the UE 100, a configuration for CG PUSCH and UTO-UCI. The UE 100 receives the configuration.

At 704, the RAN node 104 transmits, to the UE 100, a configuration for PDCCH monitoring adaptation (i.e., skipping PDCCH monitoring). The UE 100 receives the configuration.

At 705, the UE 100 transmits, to the RAN node 104, UL data on the CG resources assigned by the configuration at 703, and an indication (i.e., UTO-UCI) indicating one or more unused CG PUSCH transmission occasions in the future. The RAN node 104 receives the UL data and the UTO-UCI.

At 706, the RAN node 104 transmits, to the UE 100, an indication indicating to skip the PDCCH monitoring for a certain time duration. The UE 100 receives the indication.

At 707, when one or more CG PUSCH transmission occasions are indicated as unused (at 705), the UE 100 determines whether at least one transmission of UCI is scheduled to be transmitted in one or more slots comprising or in between the one or more unused CG PUSCH transmission occasions indicated at 705.

At 708, when the UCI is scheduled, the UE 100 determines, based on the one or more rules, whether to skip the at least one scheduled transmission of the UCI.

For example, if the UCI transmission only comprises CSI reporting information, and if skipping of PDCCH monitoring is configured at the UE 100, and/or the UE 100 is not expected to be scheduled with CSI reporting at least until the next CG PUSCH transmission occasion (based on the skipping of PDCCH monitoring), then the UE 100 may determine to skip the at least one scheduled transmission of the UCI. In this case, the UE 100 may transmit an indication to the RAN node 104 to indicate that the corresponding CG PUSCH transmission occasion is “unused”.

Alternatively, if the UCI comprises HARQ feedback (instead of or in addition to the CSI), then the UE 100 may determine to not skip the at least one scheduled transmission of the UCI. In other words, in this case, the UE 100 may transmit the at least one scheduled transmission of the UCI, regardless of the UTO-UCI indication of 705. The UE 100 may also transmit an indication to the RAN node 104 to indicate that the corresponding CG PUSCH transmission occasion is “not unused” (i.e., used).

It should be noted that the determination of whether to skip the at least one scheduled transmission of the UCI may also be based on, for example, at least one of the following conditions: the UE 100 is not under a high mobility state, the measured RSRP level from the RAN node 104 is higher than a first threshold (e.g., s-MeasureConfig), or the time duration since the previous CSI report was transmitted is less than a second threshold.

At 709, the UE 100 resumes data transmission on the assigned CG resources.

At 710, the UE 100 resumes data and UCI transmission on the assigned CG PUSCH resources or PUCCH resources.

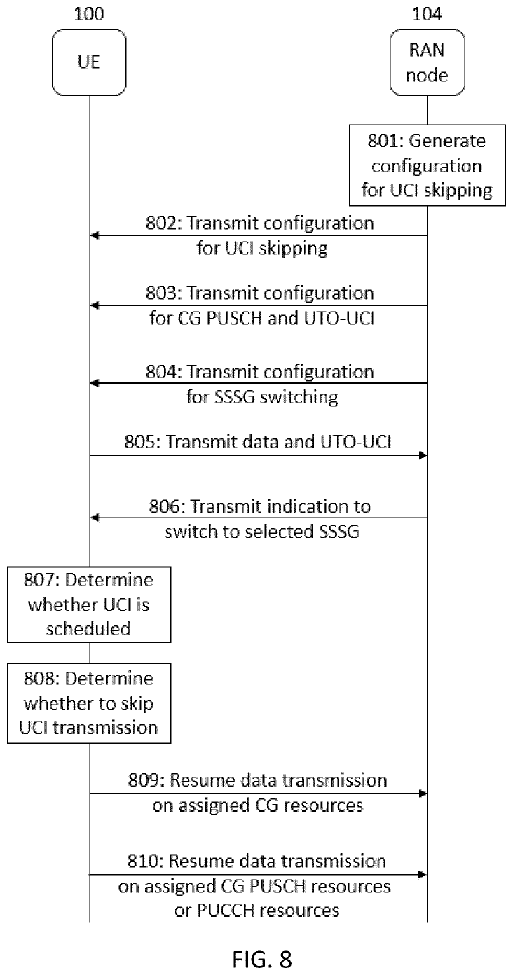

FIG. 8 illustrates a signal flow diagram according to an example embodiment for skipping UCI, when UL skipping is configured and SSSG switching is enabled (i.e., the UE needs to monitor a different SSSG than the current one). The UE 100 of FIG. 8 may be in connected mode (RRC_CONNECTED) with the RAN node 104. For example, the RAN node 104 may comprise a gNB.

Referring to FIG. 8, at 801, the RAN node 104 generates, for the UE 100, a configuration indicating one or more rules for skipping a transmission of UCI. For example, the RAN node 104 may select/determine the one or more rules as described above at 401 of FIG. 4.

At 802, the RAN node 104 transmits the configuration to the UE 100. The UE 100 receives the configuration.

At 803, the RAN node 104 transmits, to the UE 100, a configuration for CG PUSCH and UTO-UCI. The UE 100 receives the configuration.

At 804, the RAN node 104 transmits, to the UE 100, a configuration for PDCCH monitoring adaptation (i.e., SSSG switching), which indicates which (active) SSSG(s) the UE 100 is allowed to skip in the UL. The UE 100 receives the configuration.

At 805, the UE 100 transmits, to the RAN node 104, UL data on the CG resources assigned by the configuration at 803, and an indication (i.e., UTO-UCI) indicating one or more unused CG PUSCH transmission occasions in the future. The RAN node 104 receives the UL data and the UTO-UCI.

At 806, the RAN node 104 transmits, to the UE 100, an indication indicating to activate or switch to a selected SSSG (e.g., SSSG #1), for which UL skipping is allowed.

At 807, when one or more CG PUSCH transmission occasions are indicated as unused (at 805), the UE 100 determines whether at least one transmission of UCI is scheduled to be transmitted in one or more slots comprising or in between the one or more unused CG PUSCH transmission occasions indicated at 805.

At 808, if the UCI is scheduled, the UE 100 determines, based on the one or more rules, whether to skip the at least one scheduled transmission of the UCI.

For example, if the UCI transmission only comprises CSI reporting information, and if the UE 100 is configured to monitor the selected SSSG (i.e., UL skipping is configured and SSSG switching is enabled), and/or the UE 100 is not expected to be scheduled with CSI reporting at least until the next CG PUSCH transmission occasion (based on the PDCCH monitoring periodicity), then the UE 100 may determine to skip the at least one scheduled transmission of the UCI. In this case, the UE 100 may transmit an indication to the RAN node 104 to indicate that the corresponding CG PUSCH transmission occasion is “unused”.

Alternatively, if the UCI comprises HARQ feedback (instead of or in addition to the CSI), and even if the UCI transmission would occur in the one or more slots where the UTO-UCI indicated the one or more unused CG PUSCH transmission occasions, then the UE 100 may determine to not skip the at least one scheduled transmission of the UCI. In other words, in this case, the UE 100 may transmit the at least one scheduled transmission of the UCI, regardless of the UTO-UCI indication of 805. The UE 100 may also transmit an indication to the RAN node 104 to indicate that the corresponding CG PUSCH transmission occasion is “not unused” (i.e., used).

It should be noted that the determination of whether to skip the at least one scheduled transmission of the UCI may also be based on, for example, at least one of the following conditions: the UE 100 is not under a high mobility state, the measured RSRP level from the RAN node 104 is higher than a first threshold (e.g., s-MeasureConfig), or the time duration since the previous CSI report was transmitted is less than a second threshold.

At 809, the UE 100 resumes data transmission on the assigned CG resources, which may be indicated as “not unused” in UTO-UCI, and/or switched (e.g., by DCI or timer) to another SSSG.

At 810, the UE 100 resumes data and UCI transmission on the assigned CG PUSCH resources or PUCCH resources.

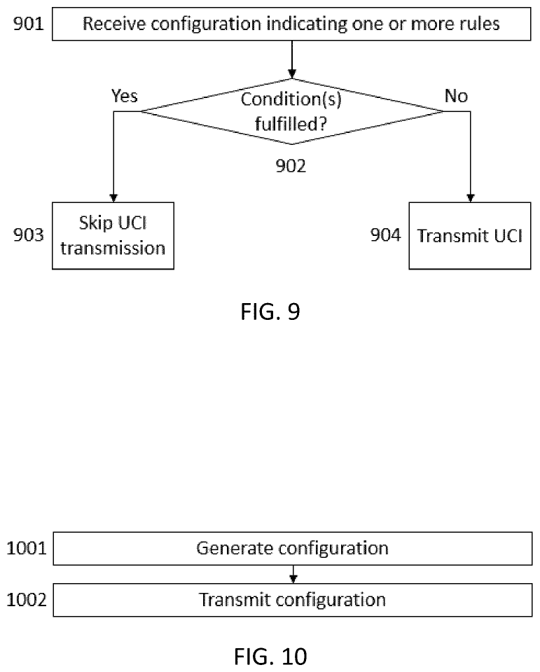

FIG. 9 illustrates a flow chart according to an example embodiment of a method performed by an apparatus 1300. For example, the apparatus 1300 may be, or comprise, or be comprised in, a user equipment (UE) 100, 102.

Referring to FIG. 9, in block 901, the apparatus 1300 receives, from a radio access network node 104, a configuration indicating one or more rules for skipping (i.e., omitting) a transmission of uplink control information. The one or more rules may indicate that uplink transmission can be skipped (omitted), if one or more conditions are fulfilled.

The one or more rules comprise at least a condition that an indication indicating one or more unused configured grant physical uplink shared channel transmission occasions has been transmitted.

In block 902, the apparatus 1300 determines, based on the one or more rules, whether to skip at least one scheduled transmission of the uplink control information. In other words, the apparatus 1300 determines whether the one or more conditions indicated by the one or more rules are fulfilled.

The uplink control information may be carried on a physical uplink control channel (PUCCH) or multiplexed on a physical uplink shared channel (PUSCH).

The at least one scheduled transmission of the uplink control information may be scheduled in one or more slots comprising or in between the one or more unused configured grant physical uplink shared channel transmission occasions.

In block 903, based on determining to skip the at least one scheduled transmission of the uplink control information (block 902: yes), the apparatus 1300 may skip the at least one scheduled transmission of the uplink control information. The skipping means that the at least one scheduled transmission of the uplink control information is not transmitted.

Alternatively, in block 903, based on determining to not skip the at least one scheduled transmission of the uplink control information (block 902: no), the apparatus 1300 may transmit the at least one scheduled transmission of the uplink control information.

For example, the one or more rules may indicate to skip the at least one scheduled transmission of the uplink control information based on at least one of the following conditions: the at least one scheduled transmission does not carry any uplink user data, the uplink control information does not carry hybrid automatic repeat request feedback for a downlink transmission, the uplink control information carries a channel state information report, the apparatus 1300 is not under a high mobility state, a measured reference signal received power level from the radio access network node is higher than a first threshold, a time duration since transmitting a previous channel state information report is less than a second threshold, the apparatus 1300 is configured to skip physical downlink control channel monitoring, or search space set group switching is enabled at the apparatus 1300.

FIG. 10 illustrates a flow chart according to an example embodiment of a method performed by an apparatus 1400. For example, the apparatus 1400 may be, or comprise, or be comprised in, a network node 104 of a radio access network.

Referring to FIG. 10, in block 1001, the apparatus 1400 generates a configuration for a user equipment 100, the configuration indicating one or more rules for skipping a transmission of uplink control information. The one or more rules comprises at least a condition that an indication indicating one or more unused configured grant physical uplink shared channel transmission occasions has been transmitted from the user equipment.

In block 1002, the apparatus 1400 transmits the configuration to the user equipment 100.

The apparatus 1400 may select/determine the one or more rules, possibly from a set of pre-defined or pre-configured rules, wherein the selection/determination may be based on at least one of: whether the user equipment 100 is expected to transmit uplink user data, whether the user equipment 100 is expected to transmit hybrid automatic repeat request feedback for a downlink transmission, whether the user equipment 100 is expected to transmit a channel state information report, whether the user equipment 100 is under a high mobility state, a measured reference signal received power level reported from the user equipment 100, a time duration since the user equipment 100 transmitted a previous channel state information report, or downlink power saving settings of the user equipment 100.

The blocks, related functions, and information exchanges (messages) described above by means of FIGS. 4-10 are in no absolute chronological order, and some of them may be performed simultaneously or in an order differing from the described one. For example, step 508 of FIG. 5 may alternatively be performed before step 507 of FIG. 5, or step 706 of FIG. 7 may alternatively be performed before step 705 of FIG. 7, or step 806 of FIG. 8 may alternatively be performed before step 805 of FIG. 8. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The example embodiments described above may provide several technical advantages from both the UE and network perspective, such as reduced power consumption, more efficient use of radio resources, and reduced interference. For example, the skipping of UL PUCCH or PUSCH transmissions enables power saving at the UE, since a smaller number of transmissions will be performed. At the same time, the network (e.g., the RAN node 104) may skip the decoding of those radio resources that are dedicated to UE transmissions, but eventually left unused. Additionally, pre-allocated UL transmissions skipped by the UE reduce the usage of radio resources and the interference caused to other UEs (e.g., UEs that are close to the cell edge).

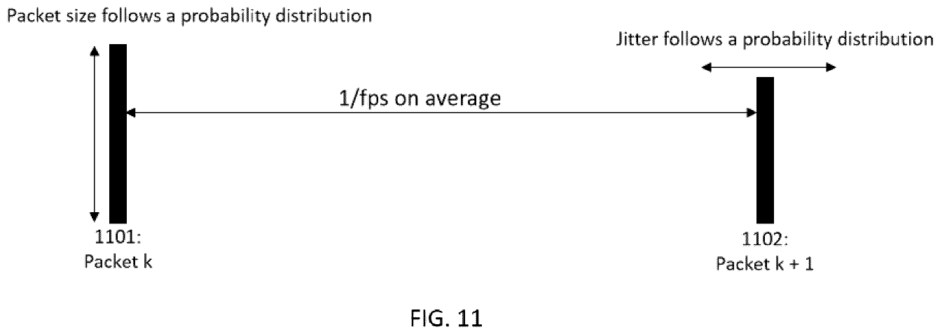

FIG. 11 illustrates an example of a single-stream traffic model for UL video traffic of XR services, which may be used as an example to quantify the power saving gain of the UE. In FIG. 11, the XR traffic is modelled as a sequence of video frames arriving at the RAN node 104 according to the considered video frame rates and random jitter. The size of a given frame is also random according to a certain probability distribution. In FIG. 11, the packet 1101 (packet k) represents internet protocol (IP) packets belonging to video frame k, and the packet 1102 (packet k+1) represents IP packets belonging to video frame k+1).

The size of a packet 1101, 1102 may be determined by the given data rates and frame rates, which may be modelled as a random variable following truncated Gaussian distribution with the following statistical parameters shown in Table 1 below.

TABLE 1

| | | Baseline values |
|---|---|---|
| Parameter | unit | for evaluation |
| Mean (M) | byte | R × 1e6/F/8 |
| Standard | byte | 10.5% of M |
| deviation (STD) | | |
| Max | byte | 150% of M |
| Min | byte | 50% of M |

R: data rate of the flow in Mbps.
F: frame generation rate of the flow in frames per second (fps).
Note that the mean and STD apply before truncation applies.
Note that the value of R, F depend on application.

In this model, the packet arrival rate may be determined by the frame generation rate (e.g., 60 fps). Accordingly, the average packet arrival periodicity may be given by the inverse of the frame rate (e.g., 16.6667 ms=1/60 fps). The periodic arrival without jitter gives the arrival time at the RAN node 104 for a packet with index k (=1, 2, 3 . . . ) as k/F*1000 [ms], where F is the given frame generation rate (per second). The varying frame encoding delay and network transfer time may introduce jitter in the packet arrival time at the RAN node 104. In this model, the jitter is modelled as a random variable added on top of periodic arrivals. The jitter may follow truncated Gaussian distribution with the following statistical parameters shown in Table 2.

TABLE 2

| | | Baseline value |
|---|---|---|
| Parameter | unit | for evaluation |
| Mean | ms | 0 |
| STD | ms | 2 |
| Truncation | ms | [−4, 4] |
| range | | |

Some examples for the frame generation rates considered for XR services may include 30, 60, 90, and 120 fps. In the evaluation herein, 60 fps is considered as the baseline.

Thus, the periodic arrival with jitter gives the arrival time for packet with index k (=1, 2, 3 . . . ) as offset+k/F*1000+J [ms], where F is the given frame generation rate (per second), and J is a random variable capturing jitter. Note that actual traffic arrival timing of traffic for a given UE may be shifted by the UE-specific arbitrary offset.

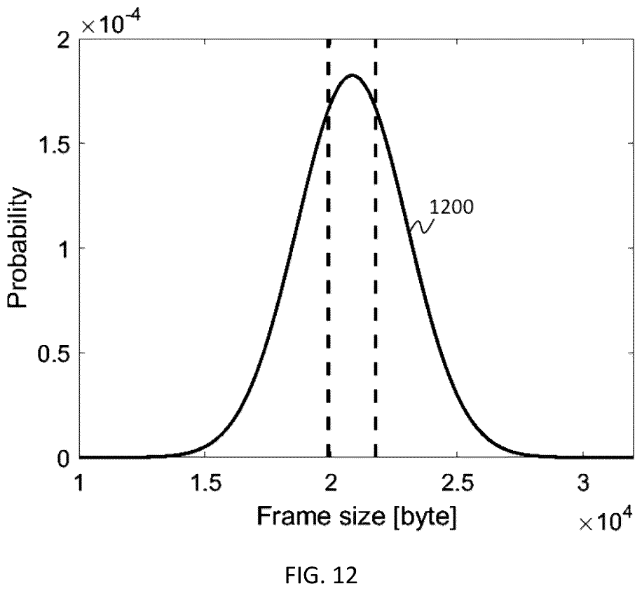

Assuming a video stream with data rate R=10 Mbps and frame rate F=60 fps, the single-stream traffic model provides the following statistical properties for the frame size distribution shown in Table 3 and FIG. 12.

TABLE 3

| | | Baseline values |
|---|---|---|
| Parameter | unit | for evaluation |
| Mean: M | byte | 20833 |
| STD | byte | 2187 |
| Max | byte | 31250 |
| Min | byte | 10416 |

FIG. 12 illustrates an example of a distribution 1200 of frame size. The frame size distribution 1200 depicted in FIG. 12 has been divided into three equiprobable intervals (i.e., all intervals have the same probability).

This way, the transmission of the XR frame with the maximum size can be divided into three transmission opportunities, each carrying a portion of the XR frame. In particular, a transmission opportunity should be dimensioned with enough radio resources to carry the difference between the maximum values of two adjacent intervals.

Alternatively, the frame size distribution can be divided into three intervals with the same size (i.e., the size of each interval is equal to one third of the maximum frame size). With this alternative splitting of the frame size distribution, each transmission opportunity should be dimensioned with enough radio resources to carry at least one third of the maximum frame size.

In the analysis of the power saving gain, the alternative with three equiprobable intervals is analyzed. To provide an estimation of the potential power saving gain, the following assumptions may be made.

As a first assumption, the system uses numerology 1 (i.e., subcarrier spacing and slot duration are equal to 30 kHz and 0.5 ms, respectively) and a time-division duplexing (TDD) radio frame “DDDSU”.

As a second assumption, three CG configurations have been set up with parameters indicated in Table 4. Each CG configuration has a CG period composed of three transmission opportunities in three consecutive slots.

As a third assumption, each transmission opportunity in each CG period is allocated a number of radio resources according to the strategy of equiprobable intervals described above.

TABLE 4

| | | | Number of |
|---|---|---|---|
| CG | CG | Duration of | transmission |
| configuration | periodicity | CG period | opportunities |
| 1 | 50 ms | 17 | 3 |
| 2 | 50 ms | 17 | 3 |
| 3 | 50 ms | 16 | 3 |

Under these assumptions, in each CG period, one XR frame arrival has a ⅓ probability to be carried in a single CG occasion (out of the three CG occasions), ⅓ probability to be carried in two CG occasions (out of the three CG occasions), and ⅓ probability to be carried in three CG occasions (out of the three CG occasions). Therefore, on average, the UE can cancel three CG occasions in a period of 50 ms. The power saving gain also depends on the frequency of CSI reporting.

If the CSI is carried in PUCCH, and the PUCCH falls in the same slots as the CG transmission opportunities over PUSCH, then there are a maximum of 9 CSI reports in the 50 ms period. The average power saving gain for UL is therefore equal to 100*(3/9)=33.3%.

If CSI reporting has the same frequency of UL slots, there are 20 CSI reports in the 50 ms period, out of which 3 can be cancelled. The minimum power saving gain for UL is equal to 100*(3/20)=15%. Note that if more than one CSI report is skipped after UTO-UCI (e.g., all CSI are skipped until the next CG transmission opportunity), then the average power saving gain can still achieve 100*(3/9)=33.3%.

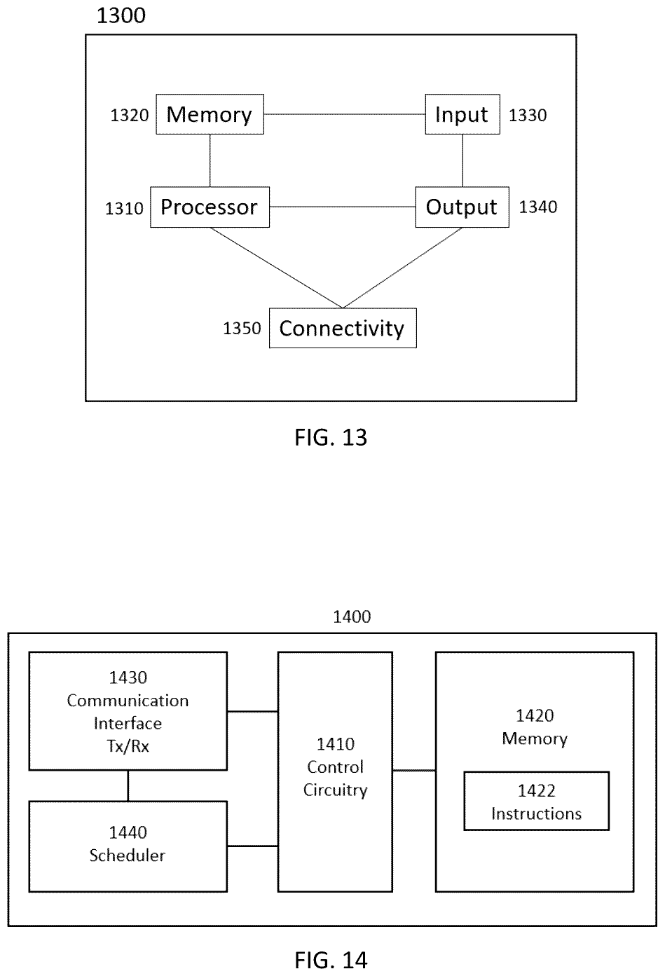

FIG. 13 illustrates an example of an apparatus 1300 comprising means for performing one or more of the example embodiments described above. For example, the apparatus 1300 may be an apparatus such as, or comprising, or comprised in, a user equipment (UE) 100, 102. The user equipment may also be called a wireless communication device, a subscriber unit, a mobile station, a remote terminal, an access terminal, a user terminal, a terminal device, or a user device.

The apparatus 1300 may comprise a circuitry or a chipset applicable for realizing one or more of the example embodiments described above. For example, the apparatus 1300 may comprise at least one processor 1310. The at least one processor 1310 interprets instructions (e.g., computer program instructions) and processes data. The at least one processor 1310 may comprise one or more programmable processors. The at least one processor 1310 may comprise programmable hardware with embedded firmware and may, alternatively or additionally, comprise one or more application-specific integrated circuits (ASICs).

The at least one processor 1310 is coupled to at least one memory 1320. The at least one processor is configured to read and write data to and from the at least one memory 1320. The at least one memory 1320 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1320 stores computer readable instructions that are executed by the at least one processor 1310 to perform one or more of the example embodiments described above. For example, non-volatile memory stores the computer readable instructions, and the at least one processor 1310 executes the instructions using volatile memory for temporary storage of data and/or instructions. The computer readable instructions may refer to computer program code.

The computer readable instructions may have been pre-stored to the at least one memory 1320 or, alternatively or additionally, they may be received, by the apparatus, via an electromagnetic carrier signal and/or may be copied from a physical entity such as a computer program product. Execution of the computer readable instructions by the at least one processor 1310 causes the apparatus 1300 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1300 may further comprise, or be connected to, an input unit 1330. The input unit 1330 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1330 may comprise an interface to which external devices may connect to.

The apparatus 1300 may also comprise an output unit 1340. The output unit may comprise or be connected to one or more displays capable of rendering visual content, such as a light emitting diode (LED) display, a liquid crystal display (LCD) and/or a liquid crystal on silicon (LCoS) display. The output unit 1340 may further comprise one or more audio outputs. The one or more audio outputs may be for example loudspeakers.

The apparatus 1300 further comprises a connectivity unit 1350. The connectivity unit 1350 enables wireless connectivity to one or more external devices. The connectivity unit 1350 comprises at least one transmitter and at least one receiver that may be integrated to the apparatus 1300 or that the apparatus 1300 may be connected to. The at least one transmitter comprises at least one transmission antenna, and the at least one receiver comprises at least one receiving antenna. The connectivity unit 1350 may comprise an integrated circuit or a set of integrated circuits that provide the wireless communication capability for the apparatus 1300. Alternatively, the wireless connectivity may be a hardwired application-specific integrated circuit (ASIC). The connectivity unit 1350 may also provide means for performing at least some of the blocks or functions of one or more example embodiments described above. The connectivity unit 1350 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1300 may further comprise various components not illustrated in FIG. 13. The various components may be hardware components and/or software components.

FIG. 14 illustrates an example of an apparatus 1400 comprising means for performing one or more of the example embodiments described above. For example, the apparatus 1400 may be an apparatus such as, or comprising, or comprised in, a network node 104 of a radio access network.

The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1400 may comprise, for example, a circuitry or a chipset applicable for realizing one or more of the example embodiments described above. The apparatus 1400 may be an electronic device comprising one or more electronic circuitries. The apparatus 1400 may comprise a communication control circuitry 1410 such as at least one processor, and at least one memory 1420 storing instructions 1422 which, when executed by the at least one processor, cause the apparatus 1400 to carry out one or more of the example embodiments described above. Such instructions 1422 may, for example, include computer program code (software). The at least one processor and the at least one memory storing the instructions may provide the means for providing or causing the performance of any of the methods and/or blocks described above.

The processor is coupled to the memory 1420. The processor is configured to read and write data to and from the memory 1420. The memory 1420 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1420 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1420 or, alternatively or additionally, they may be received, by the apparatus, via an electromagnetic carrier signal and/or may be copied from a physical entity such as a computer program product. Execution of the computer readable instructions causes the apparatus 1400 to perform one or more of the functionalities described above.

The memory 1420 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1400 may further comprise or be connected to a communication interface 1430, such as a radio unit, comprising hardware and/or software for realizing communication connectivity with one or more wireless communication devices according to one or more communication protocols. The communication interface 1430 comprises at least one transmitter (Tx) and at least one receiver (Rx) that may be integrated to the apparatus 1400 or that the apparatus 1400 may be connected to. The communication interface 1430 may provide means for performing some of the blocks for one or more example embodiments described above. The communication interface 1430 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1430 provides the apparatus with radio communication capabilities to communicate in the wireless communication network. The communication interface may, for example, provide a radio interface to one or more UEs 100, 102. The apparatus 1400 may further comprise or be connected to another interface towards a core network 110, such as the network coordinator apparatus or AMF, and/or to the access nodes 104 of the wireless communication network.

The apparatus 1400 may further comprise a scheduler 1440 that is configured to allocate radio resources. The scheduler 1440 may be configured along with the communication control circuitry 1410 or it may be separately configured.

It is to be noted that the apparatus 1400 may further comprise various components not illustrated in FIG. 14. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
receive, from a radio access network node, a configuration indicating one or more rules for skipping a transmission of uplink control information,
wherein the one or more rules comprise at least a condition that an indication indicating one or more unused configured grant physical uplink shared channel transmission occasions has been transmitted; and
determine, based on the one or more rules, whether to skip at least one scheduled transmission of the uplink control information.

2.-16. (canceled)
